(19) United States
(12) Patent Application Publication
(10) Pub. No.: US 2024/0301334 A1
(43) Pub. Date: Sep. 12, 2024

(54) Process for Maturing Wine

(71) Applicant: Bryce A. Ecklein, Friday Harbor, WA (US)

(72) Inventor: Bryce A. Ecklein, Friday Harbor, WA (US)

(21) Appl. No.: 18/104,303

(22) Filed: Feb. 1, 2023

(51) Int. Cl. C12H 1/22; C12G 3/07

(52) U.S. Cl. CPC C12H 1/22; C12G 3/07

(57) ABSTRACT

A process and means for maturing large volumes of wine where the wine experiences controlled oxygenation through contact with oak and external air/oxygen sources. Wine from large holding tanks (500-10,000+ gallons) is passed through airtight baffle tanks containing cored oak baffles before being returned to the larger holding tank(s).

This application claims the benefit of provisional patent application Ser. No. 63/307,572 filed Feb. 7, 2023 by the present inventor, which is incorporated by reference in its entirety.

This application uses the cored oak slabs (baffles) disclosed in my patent 6378419B1, granted Apr. 30, 2002, which is incorporated by reference in its entirety.

### BACKGROUND ART

The U.S. Pat. No. 6,378,419B1 (granted to the applicant of the current invention presented herein) achieves, at a smaller scale, the necessary controlled oxygenation of wine through oak. Aging of wine using this methodology and related fabrication has produced outstanding results in total time of maturation, wine quality achieved and cost of fabrication. The current invention, presented herein, provides a new means of oak aging large volumes of wine, heretofore unavailable to production wineries, based on the technology of above cited U.S. Pat. No. 6,378,419B1 but applied in a new, scalable embodiment with associated physical and methodological components.

A review of the limited examples of relevant prior art discloses attempts to address wine aging of larger volumes of wine. Cited disclosures all fail to achieve the oxygenation of wine through oak at a scale, efficiency, or practicality of the current subject invention.

U.S. Patent 20190177675A1 shows a series of four actual oak barrels interconnected to each other and to an external wine holding tank. Wine is fed through the barrels for aging and returned to the holding tank. In reality this is nothing much more than what happens in a production winery where numerous, individual, unconnected, barrels are used, and the aged wine produced therein is then cross-blended into one large container before bottling. This prior art relies on the costly use of oak barrels in the first instance and then replacement of same once the oak flavors have been spent to allow continuance of the process. Additionally, the physical accommodation of the barrels requires stacking and accomplishes nothing in terms of space utilization or ease of maintenance. It is doubtful that either the physical aspects or practicality of this invention would be of use to a production winery.

U.S. Patent 20200010785A1 (now abandoned) shows a barrel-sized container for aging wine that has both external walls of oak and an internal sealed oak air box that is placed in the wine. The air box is intended to provide a source of additional air to aid the maturation process. The patent describes the prospect of using a single aging tank or connecting several such units together and feeding wine through them from an external tank and then returning the wine to the external tank.

Were such an invention to be placed in a production winery, the drawbacks would become immediately apparent. Not only would the oak used in the container surrounds need to be replaced frequently to provide desired oak flavors, but the internal air box would need to be replaced continuously to achieve an adequate source of fresh air. As with human lungs, once the air in the sealed oak box has been inhaled (passage through the oak to the wine), it is spent and changes chemically to a potentially toxic gas (CO2) which must be removed from the aging wine environs. This invention has no practical application in a production winery and is incapable of maturing larger volumes of wine due to the lack of a continuous air supply for required oxygenation of the wine.

### SUMMARY OF THE INVENTION

Because of the high cost of oak barrels, their storage and maintenance requirements, the majority of produced wines never go through barrel aging. This results in an inferior, less complex and less desirable product. The current invention provides a process and means to obtain proper maturation including desirable flavor profiles and mouth feel through an oak aging process that can be used economically and efficiently for large quantities of wine. In practice, volumes ranging from 500 gallons to 10,000 gallons and greater, as may be used in production wineries, are suitable for this process. Maturation of the wine is accomplished through controlled oxygenation as is achieved by transfer of oxygen through oak.

The benefit of aging wine in oak barrels has been documented extensively in research papers, trade journals and numerous patent applications. One key finding of all such documentation is the need for subtle, but controlled, oxygenation of the wine being aged by the contact of air through the oak barrel to the wine contained in the barrel. This contact causes a necessary and desirable chemical reaction in which certain compounds and flavors in the oak and wine are extracted and/or modified. Without oxygenation, as occurs in a steel tank, there would be no reduction of harsh tannins in the wine and no integration of the various flavors present in the oak structure or flavonoids present in the wine. Merely placing oak in any form into a volume of wine does not accomplish the same result even when oxygen is introduced directly into the wine. The passage of air through oak, as with an oak barrel, to contact with the wine inside the barrel is the proven and time-honored process for achieving exemplary maturation and flavor profiles. Use of oak barrels, however, has the limitation of volume of wine matured and the high cost of barrels and ongoing maintenance.

The invention presented herein accomplishes the desired maturation process for large volumes of wine as may be held in tanks of 500-10,000 gallons (or more) utilizing the placement of cored oak baffles into one or more sealed baffle tanks of either steel, poly or wood. The sealed baffle tanks serve to hold the unaged wine while it matures through coming in contact with the cored oak baffles. The interior of the cored oak baffles receives a continuous supply of air/oxygen via conduits connected to outside air/oxygen sources.

The cored oak baffles are based on the concept presented in U.S. Patent 63/784,1981 as was granted to the applicant of the current invention. The use of this process represents a new application of that concept by indication of a way to mature large volumes of wine.

Wine may be repeatedly circulated through the baffle tanks as necessary to gain the desired maturation qualities.

The cored oak baffles may be replaced as needed during the maturation process once desired oak flavors in the baffles have been expended.

The cored oak baffles may be toasted on their exterior faces and may have their exterior surface increased by dimples and/or incisions in the wood.

Any number of baffle tanks can be linked together to match the volume of wine to be matured.

### THE DRAWINGS

FIG. 1 is cutaway elevational view of the current invention showing the bulk holding tank, the airtight baffle tank and the conduit components to transfer air/oxygen and wine.

FIG. 2 is a cutaway plan of current invention showing the bulk holding tank, the airtight baffle tanks, as may be utilized in multiples, and the conduit components to transfer air/oxygen and wine.

FIG. 3 is a cutaway sideview of the airtight baffle tank showing cored oak baffles and air/oxygen and wine conduit arrangement.

FIG. 4 is a cross-sectional view of the cored oak baffles indicating individual component oak pieces and oak pieces combined to form cored oak baffles.

### DRAWING DETAILS

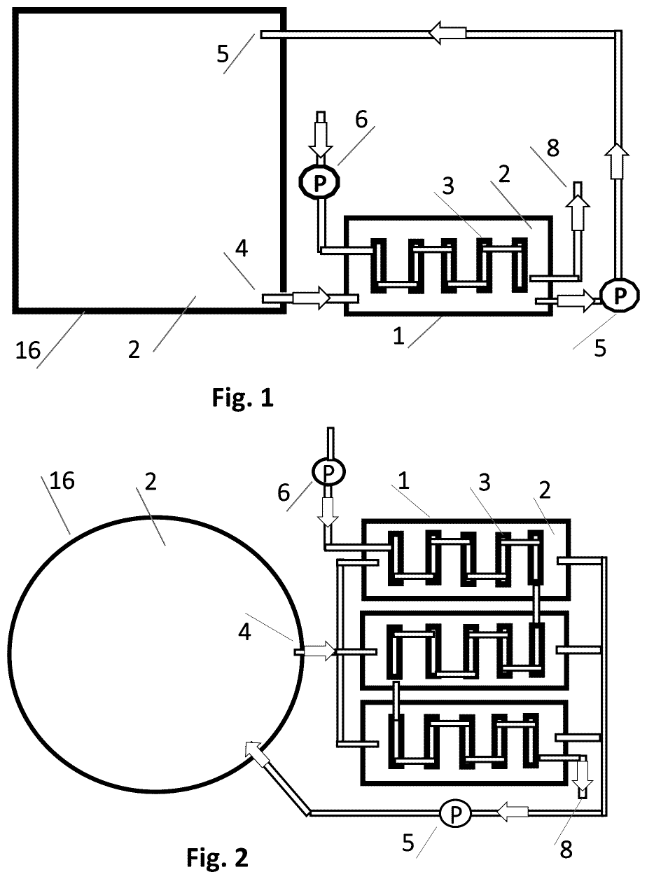

FIG. 1 shows the bulk holding tank 16, the airtight baffle tank 1 and the conduit components 4,5,6,7,8 to transfer air/oxygen and wine 2.

Unaged wine 2 held in the bulk holding tank 16 is fed in a conduit 4 by gravity to one or more airtight baffle tanks 1. The wine comes in contact with the cored oak baffles 3 which are resident in the airtight baffle tank(s). After a period of detention in the airtight baffle tank(s), the wine is pumped back to the bulk holding tank via a conduit 5.

A pumped supply of air/oxygen is provided by means of an intake conduit 6 to the cored oak baffles 3. The air/oxygen travels from one baffle to another via connector conduits 7 before exiting the airtight baffle tank(s) back to ambient air via an exit conduit 8.

FIG. 2 shows the bulk holding tank 16, the airtight baffle tanks 1 in multiples and the and the conduit components 4,5,6,7,8 to transfer air/oxygen and wine 2 within the entire system.

In particular, FIG. 2 shows potential multiples (three shown for example) of the airtight baffle tanks 1 connected together to age variable volumes of wine 1 as may come from different sizes of bulk holding tanks 16. Cored oak baffles 3 are shown along with air/oxygen and wine conduits 4,5,6,7,8.

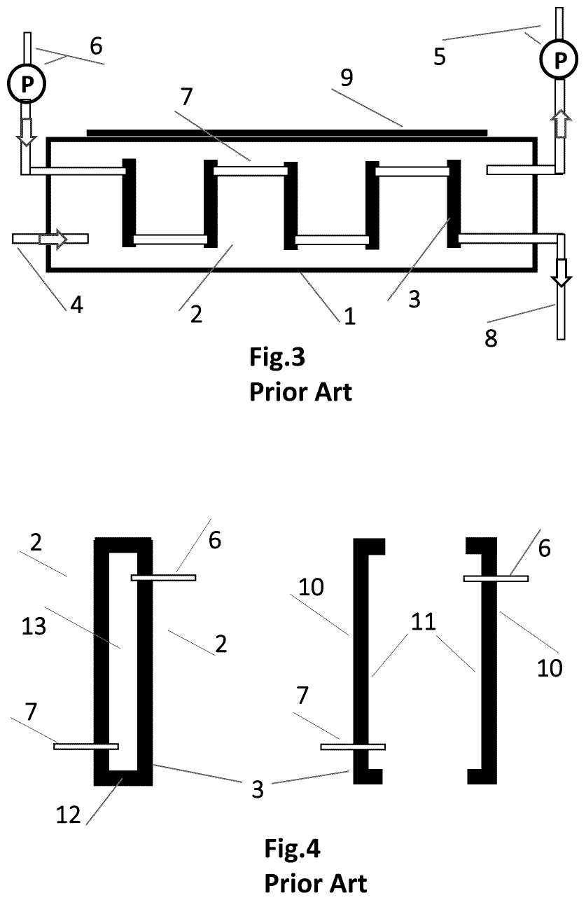

FIG. 3 shows the airtight baffle tank 1 which serves to hold the unaged wine 2 and the cored oak baffles 3.

Unaged wine is introduced to the airtight baffle tank by a valve-controlled, gravity fed intake conduit 4 from the bulk holding tank 16 (reference FIG. 1) where it surrounds and comes in direct contact with the cored oak baffles 3. Once the unaged wine has completed its resident time in the airtight baffle tank, it exits the container through a pump assisted conduit 5 back to the bulk holding tank (reference FIG. 1).

Air/Oxygen is introduced directly into the voided interior of the cored oak baffles by means of a pump-assisted intake conduit 6 capable of being pressurized. The interior voids of each cored oak baffle are connected to each other in daisy chain fashion by connector conduits 7 capable of being pressurized. Air/oxygen is then passed out of the airtight baffle tank back to ambient air from the last cored oak baffle in the chain via an exit conduit 8.

Access to interior of airtight baffle tank(s) for maintenance and change out of cored oak baffles is provided by a removable and sealable lid 9.

FIG. 4 shows a cut-away cross-section of the basic construction of the cored oak baffles 3.

Two separate pieces of dimensioned oak 10 are shown with rebated internal faces 11 that, when placed together 12, create an interior void 13. The void becomes the reservoir for exterior air/oxygen necessary for micro-oxygenation through the oak faces to surrounding wine 2.

The exterior of the oak faces may be scored or dimpled (not shown) to increase surface area in contact with the wine. The exterior of the oak faces may also be toasted to any desired level. Air/oxygen is introduced to the void by an inlet conduit 6 with air/oxygen exiting the void to the next cored oak baffle through a connector conduit 7.

1. A means for maturation of unaged wines comprising and in combination:
(a) a liquid flow-through process achieving desired micro-oxygenation by exposing said unaged wine to air or oxygen in the presence of oak and
(b) control of said air/oxygen contact through use of cored oak baffles and
(c) said cored oak baffles are resident in an airtight baffle tank and
(d) Said cored oak baffles being internally voided to allow air passage and
(e) said cored oak baffles connected pneumatically one to another as necessary and to external air or oxygen source and
(f) said airtight baffle tank has a removable air-tight lid to allow change out of said cored oak baffles and
(g) where said cored oak baffles may be of mixed oak species and be of any toast level prescribed by the winemaker and
(h) where said cored oak baffles may have grooves, dimples or other indentations to increase area of exposed outer surface to said unaged wine and
(f) said unaged wine is supplied by gravity to said airtight baffle tank from an adjacent bulk holding tank and returned to same by pumping and
(g) resident time for said unaged wine in said airtight baffle tank varies based on direction of wine maker and
(h) Where said airtight baffle tank can vary from 5 gallons to in excess of 200 gallons dependent on winery layout and capacity of said bulk holding tank.

2. A means for maturation of unaged wines comprising and in combination:
(a) a liquid flow-through process where said unaged wine is delivered by the force of gravity and pneumatic connection from said bulk holding tank to said airtight baffle tank and
(b) where said unaged wine may be resident in said airtight baffle tank for any period of time deemed desirable by the winemaker prior to being returned by pump force to said bulk holding tank and
(c) where any number of said airtight baffle tanks may be used simultaneously and in combination to process said unaged wine from said bulk holding tank.
